(19) United States
(12) Patent Application Publication
(10) Pub. No.: US 2015/0316033 A1
(43) Pub. Date: Nov. 5, 2015

(54) CONVERTER SYSTEM AND WIND OR WATER POWER PLANT

(71) Applicant: MOOG UNNA GMBH, Unna (DE)

(72) Inventors: Tobias Rosmann, Dortmund (DE); Matthias Pauli, Bad Wunneberg (DE); Ray Opie, Orchard Park, NY (US)

(21) Appl. No.: 14/646,260

(22) PCT Filed: Nov. 22, 2013
(86) PCT No.: PCT/EP2013/074466

§ 371 Date: May 20, 2015

(30) Foreign Application Priority Data
Nov. 23, 2012 (EP) 12194100.9

(51) Int. Cl. F03D 7/04; H02H 7/122; F03B 15/00

(52) U.S. Cl. CPC F03D 7/042; F03B 15/00; H02H 7/1222

(57) ABSTRACT

A converter system with a rectifier (1) and at least two inverters (2) is described and depicted, wherein the rectifier (1) can be supplied with energy from an alternating current source (3), the rectifier (1) is connected to each of the inverters (2) via a common direct voltage circuit (4) in order to supply energy to the inverters (2) and each inverter (2) can be connected to a respective electrical load (5) in order to supply energy to the respective electrical load (5). According to the invention, a converter system that is especially reliable is realized in that a decoupling device (6) is arranged in at least one of the connections between the direct current circuit (4) and one of the inverters (2), wherein the decoupling device (6) prevents electrical energy coming from the inverter (2) from being transmitted in the direction of the direct current circuit (4). A wind or water power plant with a rotor is also described and presented, wherein the rotor comprises a rotor hub and at least two rotor blades and the rotor blades can be rotated about their respective longitudinal axes by electrical loads (5). According to the invention, a wind or water power plant that is especially reliable is realized in that the wind or water power plant comprises a converter system according to one of the claims 1 through 11, wherein the converter system supplies the loads (5) with energy.

The invention relates to a converter system with a rectifier and at least two inverters, wherein the rectifier can be supplied with energy by an alternating current source, the rectifier is connected to each of the inverters via a common direct current circuit in order to supply energy to the inverters and each inverter can be connected to a respective electrical load in order to supply energy to the respective electrical load.

U.S. Pat. No. 7,126,236 B2 discloses a method and a system for supplying energy to at least one direct current motor of a wind power plant, wherein the system comprises a bridge rectifier, which is connected to an energy source, to generate direct current and to make this available to the at least one direct current motor, and a link capacitor, which smooths direct current voltage and functions as an energy storage unit and energy source for the at least one direct current motor. It is additionally disclosed that multiple direct current motors are used, which are supplied with energy by separate drive systems, wherein the intermediate circuits of these drive systems are connected to one another so that energy can be exchanged between these intermediate circuits.

U.S. Pat. No. 7,740448 B2 discloses a device for controlling the blade angle of a rotor blade of a wind power plant, wherein the device comprises: a blade angle control system, which has a MOFSET-based power converter; a direct voltage circuit with a direct voltage circuit capacitor and is configured to deliver energy to the blade angle control system via the MOFSET-based power converter; a source for alternating current input energy for supplying energy to the direct voltage circuit; and a back-up battery, which is configured to deliver no energy to the direct voltage circuit if alternating current input energy is fully available; and wherein the device is additionally configured to use energy stored in the direct voltage circuit capacitor to deliver energy to the blade angle control system via the MOFSET-based power converter during a loss or interruption of alternating current input energy and to maintain charge in the direct voltage circuit capacitor when using the reserve battery, as soon as the voltage via the direct voltage circuit capacitor drops while energy is being supplied to the blade angle control system, wherein the alternating current source is a non-regenerative source, and the direct voltage circuit is shared by multiple blade angle motor systems, and wherein, additionally, the maintenance of charge to the direct voltage circuit capacitor when the charged direct reserve battery is used involves routing the current from the reserve battery to the shared direct voltage circuit.

The disadvantage of the prior art specified above is that, for example in the event of a short circuit in the intermediate circuit, in particular, in the link capacitor of one of the drive systems, all intermediate circuits can be completely discharged through this short circuit, so that none of the motors can continue to be supplied with electrical energy from the drive system. This is problematic, particularly in the case of motors that cannot be operated with direct current, since direct current motors can be switched directly to a battery or a capacitor as an alternative to operating via the drive system, in order to be operated in an emergency by at least the energy stored in the battery or the capacitor for a limited period. In contrast, this is not readily possible with alternating current motors.

The invention also relates to a wind or water power plant with a rotor, wherein the rotor comprises a rotor hub and at least two rotor blades, and the rotor blades can be rotated about their respective longitudinal axes by electrical loads.

The invention thus seeks to solve the problem of specifying a converter system and a wind or water power plant that are particularly reliable.

Proceeding from the converter system initially described, the problem derived and presented above is solved by arranging a decoupling device in at least one of the connections between the direct current circuit and one of the inverters, wherein the decoupling device prevents electrical energy coming from the inverter from being transferred in the direction of the direct current circuit. The converter system according to the invention, surprisingly, has proven to have significant advantages over the systems known from the prior art. In particular, decoupling the inverters from the direct current circuit, and thereby from one another, protects each inverter from faults appearing in the other components. Without the decoupling devices, a short circuit on the direct voltage side of an inverter, for example, would directly affect all other inverters via the direct current circuit.

According to an advantageous refinement of the invention, the decoupling device or at least one of the decoupling devices comprises at least one diode. In particular, it is advantageous if the decoupling device or at least one of the decoupling devices is comprised of at least one diode. Using one diode or multiple diodes connected in series results in a reliable decoupling of the one or more inverters from the direct current circuit, thus preventing an energy transfer from the one or the multiple inverters back into the direct current circuit.

An advantageous embodiment of the invention is characterized in that at least one of the inverters has an emergency energy storage unit, wherein the inverter can be supplied with electrical energy by the emergency energy storage unit. Providing an emergency energy storage unit makes it possible to supply the respective inverters with electrical energy stored in the emergency energy storage unit. This allows the inverter to supply the electrical loads with energy at least for a limited period in an emergency, e.g., loss of energy supply to the inverter via the direct current circuit, thus facilitating, in particular, a desired or even urgently required reaction of the electrical load in an emergency. In the case of a wind power plant, for example, such a desired or required reaction of the electrical load would be what is referred to as emergency mode. In this scenario, as many rotor blades of the wind power plant as possible are rotated out of the wind so that they no longer absorb energy from the airflow, but rather gradually bring the rotor of the wind power plant to a standstill through aerodynamic braking.

According to a particularly advantageous refinement of the invention, the one emergency energy storage unit or at least one of the multiple emergency energy storage units is comprised of capacitors, in particular ultracapacitors.

Capacitors and, above all, ultracapacitors, have proven to be especially advantageous when used in converter systems. The high storage capacity at low volumes and a clearly higher service life make them clearly superior to the batteries normally used. In particular, the emergency energy storage unit can consist of an individual capacitor or multiple capacitors.

In a preferred embodiment of the invention, the one emergency storage unit or at least one of the multiple emergency storage units is connected directly to a link capacitor of the respective inverter. This direct connection between the link capacitor of the respective inverter and the emergency energy storage unit allows electrical energy, which, in certain operating situations, is emitted by the electrical load to the inverter and rectified thereby, to be conducted to the emergency energy storage unit and stored there. Additionally, the direct connection of the emergency energy storage unit to the link capacitor allows the link capacitor to be designed as relatively small, i.e., with a low capacity, since the emergency energy storage unit at least partly assumes the tasks of the link capacitor. In particular, in another embodiment of the invention, the link capacitor can be designed as extremely small, that is, it can be omitted. In this case, the emergency energy storage unit functions as the link capacitor, which it replaces.

According to another preferred embodiment of the invention, the output voltage of the rectifier is adapted to the nominal voltage of the one emergency energy storage unit or of the multiple emergency energy storage units. This makes it possible to forgo having an external charging device for the one or multiple emergency energy storage units, since the one or multiple emergency energy storage units can be charged with energy that is fed from the rectifier into the direct current circuit, from which it is conducted into the inverters.

It is also advantageous if the rectifier has an overvoltage protection on the input side. This allows the complete converter system to be protected from excess voltage originating from the alternating current source. In particular, the converter system is hereby protected from overvoltages inductively injected into the alternating current source, such as those that can be caused by lightening strikes, for example.

According to another preferred refinement of the invention, the rectifier comprises a programmable logic controller. The programmable logic controller can serve, in particular, to control the rectifier and/or the inverters.

According to an advantageous embodiment of the invention, the rectifier and/or at least one of the inverters has a fieldbus interface. The fieldbus interface allows communication with other systems. Another such system can be, in particular, an overriding control device. In the case of a wind power plant, for example, an overriding control device of this type can be constituted by the plant control, which, in particular, prescribes specified values for the position of the rotor blades, wherein the compliance with the values specified is monitored by the converter system and is ensured by a corresponding activation of electrical loads connected to the inverters, in particular, electric motors.

According to another advantageous embodiment of the invention, the electrical current consumption of the rectifier is limited. Such a limitation can be achieved both by a current-limiting device that, for example, has at least one resistor, and by a corresponding control of the inverter, as is possible with an appropriate limiting current regulation, for example with a controllable bridge rectifier.

In an especially advantageous embodiment of the invention, at least one of the loads is an alternating current motor or a direct current motor.

Proceeding from the initially described wind or water power plant, the problem previously derived and presented is further solved by the wind or water power plant having a converter system according to one of the claims 1 through 11, wherein the converter system supplies the loads with energy. In a wind or water power plant of this type, the converter system is a part of what is referred to as the pitch system, which is responsible for turning the rotor blades about their respective longitudinal axes. The electrical loads are generally alternating or direct current motors.

There are a number of specific possibilities for configuring and further developing the converter system according to the invention and the wind or water power plant. In this respect, reference is made to the dependent claims to claim 1, and to the following detailed description of preferred exemplary embodiments of the invention with the aid of the drawings.

The drawings show:

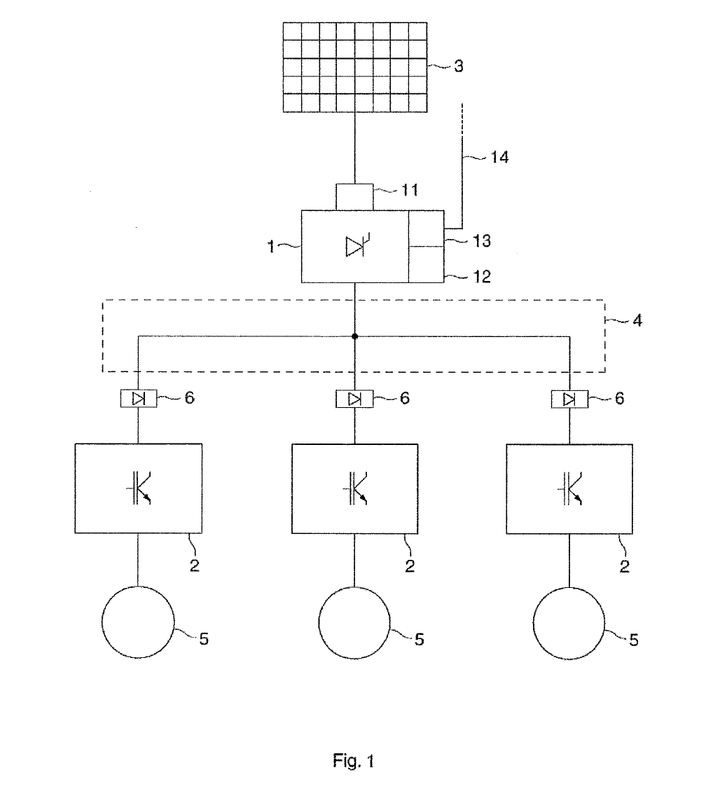

FIG. 1 a schematic diagram of the converter system of a preferred refinement of the invention according to the invention and

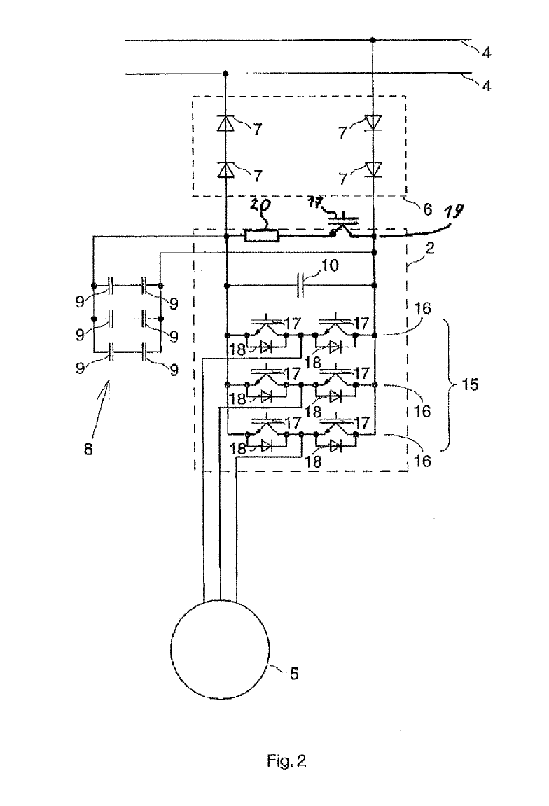

FIG. 2 a schematic diagram of a part of converter system according to the invention, in accordance with a further embodiment of the invention.

FIG. 1 shows the converter system according to the invention with a rectifier 1 and three inverters 2. The rectifier 1 is connected to an alternating current source 3, which, for example, can be the power grid. The rectifier 1 rectifies the three-phase alternating current supplied by the alternating current source 3 and makes this available to the inverters 2 via a direct current circuit 4. The rectifiers 2 are connected to electrical loads 5, which are supplied with energy from the inverters 2. The electrical loads 5 can be direct current motors or alternating current motors, for example. A decoupling device 6 is arranged at each connection between an inverter 2 and the direct current circuit 4, which prevents electrical energy coming from the inverter 2 from being transferred in the direction of the direct current circuit 4. The rectifier 1 has an overvoltage protection 11 on the input side, which protects the converter system according to the invention from overvoltages from the direct current source 3.

The rectifier 1 additionally has a programmable logic controller 12 and a fieldbus interface 13 via which the rectifier can be connected to a fieldbus 14 in order to communicate with an overriding controller (not depicted). The programmable logic controller 12 incorporates, in particular, software for controlling the rectifier 1 and the inverters 2.

FIG. 2 shows a part of converter system according to the invention in accordance with a further embodiment of the invention. The inverter 2 is connected via the decoupling device 6 to the direct current circuit 4, which is only partly shown. The decoupling device 6 is composed of four diodes 7, which are arranged in the connection lines between the inverter 2 and the direct current circuit 4. In each of the connection lines in this case, two diodes 7 are connected in series in such a manner that no electrical energy coming from the inverter 2 can be transmitted in the direction of the direct current circuit 4. The inverter 2 has a link capacitor 10, which can be charged with energy from the direct current circuit 4 via the decoupling device 6. An emergency energy storage unit 8 is connected directly to the link capacitor 10. The emergency energy storage unit 8 has multiple capacitors 9. Preferably, multiple capacitors 9 connected in series are grouped into physical units, wherein multiple such physical units connected in parallel constitute the emergency energy storage unit 8. The emergency energy storage unit 8 depicted in FIG. 2 is composed of three such physical units of two capacitors 9 each.

The inverter 2 additionally comprises a bridge arrangement 15 with which the inverter 2 is connected to the electrical load 5. The bridge arrangement 15 has three bridges 16, each of which are composed of two transistors 17 connected in series, a free-wheeling diode 18 being connected in parallel to each transistor 17. The transistors 17 are preferably bipolar transistors with insulated gate electrodes, which are also known as IGBTs (insulated-gate bipolar transistors). The free-wheeling diodes 17 enable energy from the electrical load 5 to be fed back into the link capacitor 10 and into the emergency energy storage unit 8. This can be the case, for example, if the electrical load 5 is an electric motor, which is operated as a generator 5 for at least a short period. A brake chopper 19 is provided should the electrical load 5 feed more energy back into the link capacitor 10 and the emergency energy storage unit 8 via the bridge arrangement 15 than these can safely store. Electrical energy from the link capacitor 10 and the emergency energy storage unit 8 can be converted into thermal energy by means of the brake chopper 19. For this purpose, the brake chopper 19 has a transistor 17 and a braking resistor 20. As soon as the transistor 17 is conductively switched, a current flows through the transistor 17 and the braking resistor 20. This causes the braking resistor 20 to heat up. If the voltage in the link capacitor 10 and/or in the emergency energy storage unit 8 rises above a set limit value, the transistor 17 is conductively switched and the current flow thus facilitated counteracts a further rise in voltage. A voltage sensor is provided in at least one of these components to monitor the voltage in the link capacitor 10 and/or in the emergency energy storage unit 8. In an especially advantageous embodiment, the measured value of the voltage sensor is routed to the programmable logic controller 12, and the transistor 17 of the brake chopper 19 can be actuated using the programmable logic controller 12.

Originating between the respective serially connected transistors of each bridge is an individual connection line to the electrical load 5 assigned to the inverter 2. The energy temporarily stored in the link capacitor 10 and in the emergency energy storage unit 8 can be supplied to the electrical load 5 in the form of, for example, alternating current via the bridge arrangement 15 by an appropriate activation of the transistors 17.

### LIST OF REFERENCE NUMBERS

1 Rectifier
2 Inverter
3 Alternating current source
4 Direct current circuit
5 Electrical load
6 Decoupling device
7 Diode
8 Emergency energy storage unit
9 Capacitor
10 Link capacitor
11 Overvoltage protector
12 Programmable logic control
13 Fieldbus interface
14 Fieldbus
15 Bridge arrangement
16 Bridge
17 Transistor
18 Free-wheeling diode
19 Brake chopper
20 Braking resistor

1-12. (canceled)

13. A wind or water power plant comprising:
a rotor comprising a rotor hub and at least two rotor blades;
each of the rotor blades orientated about a respective longitudinal axis;
at least two electrical loads configured to rotate the respective rotor blades about their respective longitudinal axes;
a converter system configured to supply energy to the loads;
the converter system comprising a rectifier, an alternating current source and at least two inverters;
the rectifier configured to be supplied with energy from the alternating current source and connected to each of the inverters via a common direct voltage circuit in order to supply energy to the inverters;
each inverter configured to be connected to the respective electrical load in order to supply energy to the respective electrical load;
a decoupling device arranged in at least one of the connections between the direct current circuit and one of the inverters;
wherein the decoupling device prevents electrical energy coming from the inverter from being transmitted in the direction of the direct current circuit.

14. The power plant according to claim 13, wherein the decoupling device comprises at least one diode.

15. The power plant according to claim 13, wherein at least one of the inverters comprises an emergency energy storage unit and wherein the inverter can be supplied with electrical energy by the emergency energy storage unit.

16. The power plant according to claim 15, wherein the emergency energy storage unit comprises a capacitor.

17. The power plant according to claim 16, wherein the capacitor comprises an ultracapacitor.

18. The power plant according to claim 16, wherein at least one of the respective inverters comprises a link capacitor and the emergency energy storage unit is directly connected to the link capacitor of the respective inverter.

19. The power plant according to claim 15, wherein an output voltage of the rectifier is adapted to the nominal voltage of the emergency energy storage unit.

20. The power plant according to claim 13, wherein the rectifier comprises an overvoltage protection on an input side.

21. The power plant according to claim 13, wherein the rectifier comprises a programmable logic controller.

22. The power plant according to claim 13, wherein the rectifier and/or at least one of the inverters comprises a fieldbus interface.

23. The power plant according to claim 13, wherein the rectifier has a current consumption that is limited.

24. The power plant The power plant according to claim 13, wherein at least one of the loads is an alternating current motor or a direct current motor.

25. A converter system comprising:
a rectifier;
an alternating current source;
at least two inverters;
the rectifier configured to be supplied with energy from the alternating current source and connected to each of the inverters via a common direct voltage circuit in order to supply energy to the inverters;
each inverter configured to be connected to a respective electrical load in order to supply energy to the respective electrical load;
a decoupling device arranged in at least one of the connections between the direct current circuit and one of the inverters;
wherein the decoupling device prevents electrical energy coming from the inverter from being transmitted in the direction of the direct current circuit.

26. The converter system according to claim 25, wherein the decoupling device comprises at least one diode.

27. The converter system according to claim 25, wherein at least one of the inverters comprises an emergency energy storage unit and wherein the inverter can be supplied with electrical energy by the emergency energy storage unit.

28. The converter system according to claim 27, wherein the emergency energy storage unit comprises a capacitor.

29. The converter system according to claim 28, wherein the capacitor comprises an ultracapacitor.

30. The converter system according to claim 28, wherein at least one of the respective inverters comprises a link capacitor and the emergency energy storage unit is directly connected to the link capacitor of the respective inverter.

31. The converter system according to claim 27, wherein an output voltage of the rectifier is adapted to the nominal voltage of the emergency energy storage unit.

32. The converter system according to claim 25, wherein the rectifier comprises an overvoltage protection on an input side.

33. The converter system according to claim 25, wherein the rectifier comprises a programmable logic controller.

34. The converter system according to claim 25, wherein the rectifier and/or at least one of the inverters comprises a fieldbus interface.

35. The converter system according to claim 25, wherein the rectifier has a current consumption that is limited.

36. The converter system according to claim 25, wherein at least one of the loads is an alternating current motor or a direct current motor.
